(19) United States
(12) Patent Application Publication
(10) Pub. No.: US 2026/0225456 A1
(43) Pub. Date: Aug. 6, 2026

(54) ELECTRIC VEHICLE SPEED CONTROLLER

(71) Applicant: Robert Bosch GmbH, Stuttgart (DE)

(72) Inventor: Weiliang Huang, Novi, MI (US)

(21) Appl. No.: 19/046,977

(22) Filed: Feb. 6, 2025

(51) Int. Cl. B60L 3/08; B60W 30/14; B60W 40/02; B60W 50/08; G01C 21/34

(52) U.S. Cl. CPC B60L 3/08; B60W 30/146; B60W 40/02; B60W 50/082; G01C 21/3415; B60W 2555/20

(57) ABSTRACT

Apparatus and methods for controlling electric vehicle speed. One example apparatus includes a communication interface configured to receive location information, and an electronic processor configured to obtain a plurality of environmental conditions including a traffic information grade, a weather service grade for driving conditions, a rain sensor level grade, a visibility level grade, and location perception information including an area indication, determine an initial state of the vehicle, in response to a plurality of environmental perception conditions exceeding predetermined grades, generate a first output, generate a second output based on the area indication, activate a speed inhibition mode based on the first output, the second output, and the initial state of the vehicle, and deactivate the speed inhibition mode based on a speed of the vehicle exceeding a predetermined threshold and the environmental condition triggering a predetermined safety event.

### CROSS-REFERENCE TO RELATED APPLICATIONS

Not applicable.

### TECHNICAL FIELD

Embodiments, examples, features, and aspects relate generally to vehicle speed control, and more specifically, to vehicle speed control in changing driving conditions by using environmental sensing, location awareness, and machine learning to control vehicle speed in driving environments having dynamically changing driving conditions.

### BACKGROUND

Electric vehicles (EVs) produce faster acceleration compared to traditional vehicles due to EVs'absence of gear transmission, minimal acceleration delay, and direct drive mechanisms. For example, some modern EVs accelerate from 0 to 60 mile per hour in less than 3 seconds at a relatively affordable price point.

Conditions in the driving environments may change frequently and unpredictably. For example, vehicles transitioning from parking areas to main roads encounter sudden changes in traffic density, road conditions, and visibility conditions. Similarly, urban areas present dynamic environments where pedestrians and e-bike riders create constantly changing traffic patterns, requiring continuous adjustment of vehicle speed control.

### SUMMARY

According to some aspects of the present disclosure, a speed controller comprises a communication interface configured to receive location information; and an electronic processor configured to obtain a plurality of environmental conditions including a traffic information grade, a weather service grade for driving conditions, a rain sensor level grade, a visibility level grade, and location perception information including an area indication, determine an initial state of the vehicle, in response to a plurality of environmental perception conditions exceeding predetermined grades, generate a first output, generate a second output based on the area indication; activate a speed inhibition mode based on the first output, the second output, and the initial state of the vehicle, and deactivate the speed inhibition mode based on a speed of the vehicle exceeding a predetermined threshold and the environmental condition triggering a predetermined safety event.

According to some aspects of the present disclosure, a vehicle speed control system comprises a GNSS system configured to determine vehicle location; a digital cockpit configured to display speed control information; and a speed controller configured to: obtain a plurality of environmental conditions including a traffic information grade, a weather service grade for driving conditions, a rain sensor level grade, a visibility level grade, and location perception information including an area indication, determine an initial state of the vehicle, in response to a plurality of environmental perception conditions exceeding predetermined grades, generate a first output, generate a second output based on the area indication, activate a speed inhibition mode based on the first output, the second output, and the initial state of the vehicle, and deactivate the speed inhibition mode based on a speed of the vehicle exceeding a predetermined threshold and the environmental condition triggering a predetermined safety event.

According to some aspects of the present disclosure, a computer-implemented method for electric vehicle speed control comprises obtaining, via an electronic processor, a plurality of environmental conditions including: a traffic information grade, a weather service grade for driving conditions, a rain sensor level grade, a visibility level grade, and location perception information including an area indication, determining, via the electronic processor, an initial state of the vehicle; in response to a plurality of environmental perception conditions exceeding predetermined grades, generating, via the electronic processor, a first output, generating, via the electronic processor, a second output based on the area indication; activating, via the electronic processor, a speed inhibition mode based on the first output, the second output, and the initial state of the vehicle, and deactivating, via the electronic processor, the speed inhibition mode based on a speed of the vehicle exceeding a predetermined threshold and the environmental condition triggering a predetermined safety event.

### DESCRIPTION OF THE DRAWINGS

FIG. 1 illustrates a vehicle control system according to some examples.

FIG. 2 illustrates a speed controller according to some examples.

FIG. 3 illustrates a flow diagram of the decision-making process according to some examples.

FIG. 4 illustrates a computer-implemented method for vehicle speed control according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples provided.

The system, apparatus, non-transitory computer-readable medium, and method components have been represented where appropriate by conventional symbols in the drawings, showing only those specific details that are pertinent to understanding the examples provided so as not to obscure the disclosure with details that will be readily apparent to those of ordinary skill in the art having the benefit of the description herein.

### DETAILED DESCRIPTION

Driving environments that change frequently and unpredictably present technical challenges for the speed control systems of EVs. Traditional speed control systems rely on threshold-based rules and thus cannot process multiple environmental factors simultaneously. For example, when a vehicle moves from an open road into a crowded urban area, or when weather conditions suddenly shift from clear to heavy rain while in dense traffic, or when visibility conditions change rapidly while entering and exiting underground parking areas, traditional speed control systems cannot adjust the control parameters to match these dynamic environmental transitions. EVs using traditional speed control systems thus have difficulties in maintaining speed acceleration restriction states across vehicle operating cycles. In addition, traditional systems do not combine real-time sensor data with historical location information to make predictive safety decisions.

Some examples improve an EV's speed control system through an integrated approach combining multiple data processing components. Some examples implement real-time environmental perception processing that analyzes multiple types of input including concurrent sensor inputs, weather data, and traffic conditions. In some instances, the system also includes a location-aware decision engine that classifies areas based on multiple data sources and maintains state information across operating cycles. In some examples, the system includes a machine learning (ML) routing component enhances location classification accuracy by learning from historical data and sharing this information through cloud databases.

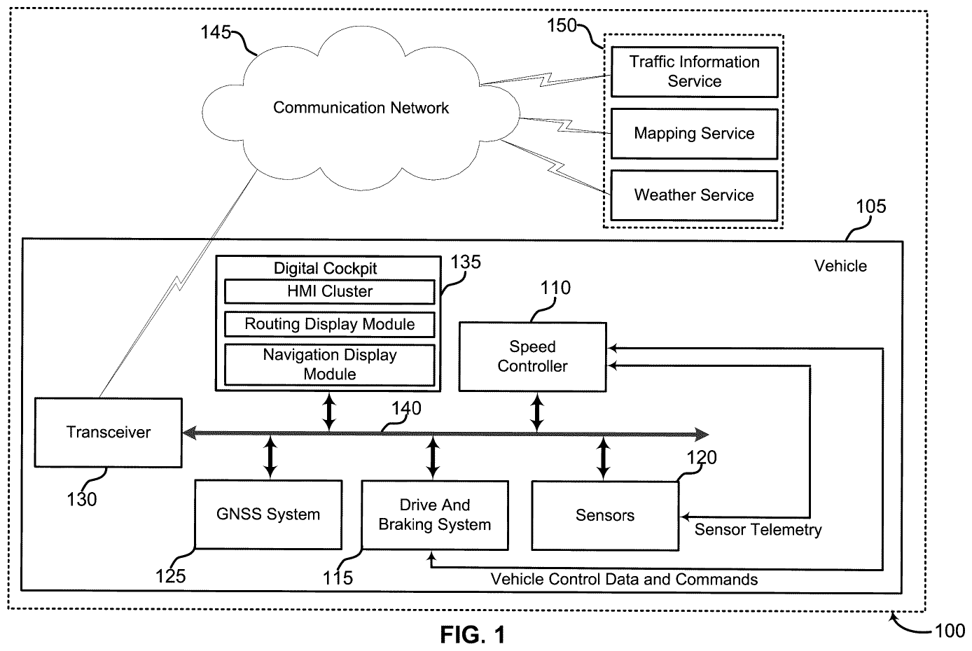

FIG. 1 is a block diagram of a vehicle control system 100 for a vehicle 105, for example, an electric vehicle. In the example shown, the vehicle control system 100 includes components outside of the vehicle 105 and components within the vehicle 105. The components outside of the vehicle 105 includes a communication network 145 and a vehicle environment service 150. The vehicle is connected to the communication network 145, and the communication network 145 in turn is connected to the vehicle environment service 150. As will be explained below, in some instances, the vehicle control system 100 and vehicle environment service 150 operate together to implement speed control operations.

The vehicle environment service 150 coordinates integrated services. In some instances, the integrated services include a traffic information service that monitors and reports traffic conditions, a mapping service that analyzes road and location data, and a weather service that tracks current and forecasted weather conditions. The vehicle environment service 150 transmits this environmental data through the communication network 145 to the vehicle control system 100. For example, the environmental data include weather service data that indicate driving conditions from clear to severe, traffic information service data that indicate traffic flow from free to severe congestion, rain sensor data that indicate precipitation levels from no rain to torrential, and light sensor data and camera sensor data that indicate visibility conditions from dark to bright daylight. In some examples, the visibility conditions at straight segment are divided into four levels, which are less than 20 meters, 20 meters to 60 meters, 60 meters to 140 meters, and more than 140 meters.

The communication network 145 may include various networks that operate in accordance with different protocols. The communication network 145 transmits data between the vehicle environment service 150 and the vehicle 105, for example, using cellular networks (5G), Wi-Fi, or other wireless communication protocols. As will be explained below, in certain instances, the communication network 145 processes both routine updates of the environmental data during stable conditions and rapid updates during changing conditions such as sudden weather shifts or traffic incidents.

The components within the vehicle 105 includes a speed controller 110 that processes data from vehicle drive and braking systems 115, sensors 120, and a global navigation satellite system (GNSS), such as a system that determines location, speed, and heading of a vehicle by processing signals from orbiting navigation satellites, i.e., a GNSS system 125, a global positioning service (GPS), or other system that provides location information. The components within the vehicle 105 also include a transceiver 130. Information gathered or determined by various components of the vehicle control system 100 is displayed via a digital cockpit 135.

In some examples, the speed controller 110, digital cockpit 135, and vehicle environment service 150 interact in a continuous operational loop. The vehicle environment service 150 transmits updates of the environmental data such as traffic, weather, and mapping updates to the speed controller 110 through the communication network 145 and transceiver 130. The speed controller 110 combines this environmental data with sensor telemetry and location information to determine speed adjustments. The digital cockpit 135 displays these speed control decisions and transmits user inputs back to the speed controller 110.

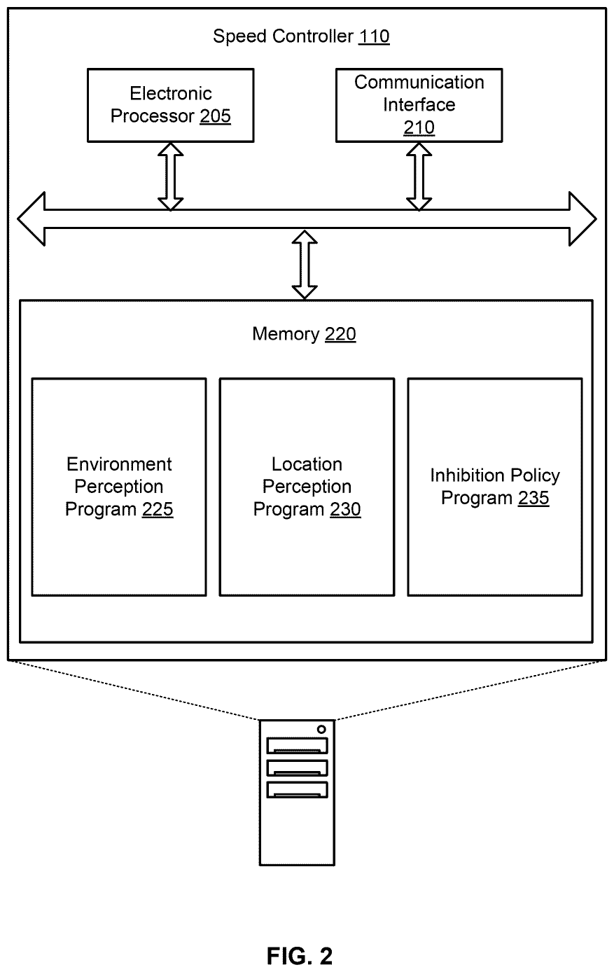

In one example, the speed controller 110 processes input data, such as data streams including sensor telemetry from the sensors 120, location data from the GNSS system 125, and environmental data from the transceiver 130. Based on the input data, the speed controller 110 calculates and transmits control commands to the vehicle drive and braking systems 115. For example, when the input data trigger speed inhibition based on exceeding a predetermined threshold, the speed controller 110 calculates speed acceleration restriction parameters and generates control commands to limit motor acceleration through the vehicle drive and braking systems 115. The speed controller 110 operates in multiple control modes based on vehicle conditions, maintaining programmed speed limits in normal mode and reducing speed thresholds in caution mode when adverse conditions are detected. The internal structure and operation of the speed controller 110 are explained in greater detail later in the discussion of FIG. 2.

In some instances, the vehicle drive and braking systems 115 execute operations that control motion or movement of the vehicle 105 based on commands from the speed controller 110. In some instances, the vehicle drive and braking systems 115 include actuators and feedback sensors that implement speed adjustments. For example, the vehicle drive and braking systems 115 adjust acceleration, braking, and steering to maintain target vehicle speeds. When the speed controller 110 commands changes, the vehicle drive and braking systems 115 coordinate multiple components to achieve speed control.

The sensors 120 measure vehicle state and environmental conditions. In some instances, the sensors 120 include cameras that capture road conditions and front visibility conditions, radar sensors that detect obstacles, LIDAR sensors that map surroundings, wheel speed sensors that track wheel speed, and acceleration sensors that monitor vehicle dynamics. The sensors 120 transmit sensed conditions (sometimes referred to as telemetry data) to the speed controller 110 for processing. The sensors 120 transmit sensor data to the speed controller 110 for processing. The speed controller 110 analyzes the sensor data to determine vehicle and environmental conditions and sends processed information to the digital cockpit 135 for display to the driver.

'As noted above, the transceiver 130 transmits data between internal vehicle components and external services through the communication network 145. In some instances, the transceiver 130 operates using multiple protocols to maintain continuous data exchange. In some examples, the transceiver 130 prioritizes data flow based on information type, transmitting safety-critical sensor data and speed control commands first, followed by navigation and routing information, and user interface updates.

In the example shown in FIG. 1, the digital cockpit 135 includes multiple display modules, including a human machine interface (HMI) cluster, a routing display module, and a navigation display module. The HMI cluster displays vehicle information and receives user inputs. The routing display module presents route options calculated by the speed controller 110. The navigation display module shows navigation guidance based on route calculations from the speed controller 110. Through these display modules, the digital cockpit 135 shows speed control status and receives manual configuration inputs.

In some examples, the cluster HMI operates in multiple display modes, showing current speed, target speed, and environmental conditions during normal operation, and displaying warning indicators when speed acceleration restrictions activate. The routing display module presents optimal routes that the speed controller 110 calculates based on current traffic grades, road classifications, and weather conditions.

In some examples, the routing display module is a machine learning (ML) routing display module that presents route predictions generated by the speed controller 110. The speed controller 110 predicts route options by analyzing historical patterns of environmental conditions and location types. The speed controller 110 processes these historical patterns through a machine learning model to calculate probability scores for different routes based on their past environmental grades and area classifications. The ML routing display module presents these route options along with the risk assessments, showing drivers which routes have histories of severe weather conditions or frequent transitions between different caution areas. The ML routing display module updates these displays as the speed controller 110 recalculates risk assessments based on changing environmental conditions.

The bus 140 connects components in the vehicle 105 for data exchange. In some instances, the bus 140 is a controller area network (CAN) bus, an automotive Ethernet, or other vehicle communication bus. In some instances, the bus 140 routes data packets based on component addresses and message types, directing speed control commands to the vehicle drive and braking system 115 and sensor data to both the speed controller 110 and digital cockpit 135.

FIG. 2 illustrates the internal components of the speed controller 110. In the example shown, the speed controller 110 includes an electronic processor 205, a communication interface 210, and a memory 220. In the example shown, the memory includes or stores multiple programs for implementing speed control functions. The programs include an environment perception program 225, a location perception program 230, and an inhibition policy program 235.

The electronic processor 205 may include a hardware device, such as a general-purpose processor, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

The communication interface 210 manages the flow of information between the speed controller 110 and external devices.

The memory 220 includes random access memory (RAM), read-only memory (ROM), or other memory. In some examples, memory is used to store computer-readable, computer-executable software including instructions that, when executed, cause one or more electronic processors to perform various functions described herein.

The environment perception program 225, when executed by the electronic processor 205, processes environmental data from multiple sources to assess driving conditions. The electronic processor 205 executes the environment perception program 225 to analyze multiple environmental inputs. For example, the multiple environmental inputs include weather service grades that indicate driving conditions from clear to severe, traffic information service output that grades traffic flow from free to severe congestion, rain sensor data that measures precipitation levels from no rain to torrential, and light sensor data and camera sensor data that detects visibility conditions.

The electronic processor 205 combines these environmental inputs to determine when conditions warrant speed acceleration restrictions. For example, when weather service grades indicate hazardous conditions or traffic grades show severe congestion, the environment perception program 225 flags these conditions for the inhibition policy program 235.

The location perception program 230, when executed by the electronic processor 205, analyzes location data to classify driving areas and determine appropriate speed acceleration restrictions. The electronic processor 205 executes the location perception program 230 to process location information from multiple inputs. The multiple inputs include geographical position data from the GNSS system 125, mapping service data and location navigation map data that identify road types and features, and real-time location data from the sensors 120 including lidar-cameras that classify the surrounding environment. The location perception program 230 categorizes areas into distinct types including high caution areas that require significant speed acceleration restrictions (for example, school zones, construction areas), and open driving areas that allow maximum permitted speeds. In some examples, the electronic processor 205 continuously updates these area classifications as the vehicle moves, combining sensor data with map information to maintain accurate location-based speed control decisions.

The inhibition policy program 235, when executed by the electronic processor 205, implements a multi-stage decision process to control vehicle speed based on various triggers and conditions. The electronic processor 205 executes the inhibition policy program 235 to analyze vehicle states, environmental conditions, and user inputs simultaneously. For example, when the vehicle transitions from a parked state to driving state in location-sensitive areas such as downtown or underground parking, the program automatically activates speed inhibition and maintains this restriction until the vehicle reaches a main road or less restricted area.

In some examples, the inhibition policy program 235 processes environmental conditions through real-time sensor data analysis. For example, the program detects situations such as narrow roads with mixed traffic including e-bikes, and automatically restricts vehicle speed to 30 km/h until sensors confirm safe conditions. The program also combines multiple environmental factors, such as precipitation levels from rain sensors and visibility conditions from light sensors and camera data processing with computer vision, to determine speed acceleration restrictions.

In some examples, the inhibition policy program 235 makes a speed control decision based on both the real-time sensor data and historical data. For example, the inhibition policy program 235 maintains active speed acceleration restrictions based on persistent conditions and vehicle state history. For example, when the vehicle enters an underground parking area, the program records this state before “ignition off” and maintains speed acceleration restrictions upon next “ignition on” until the vehicle exits the restricted area. It should be understood that an ignition state (ignition off or ignition on) refers to a current state of the vehicle and whether the engine is on or off or in an accessory mode. Even in an electric vehicle, these terms are used due to their historic usage. The states are often determined or changes as a result of a “start engine” or similar switch.

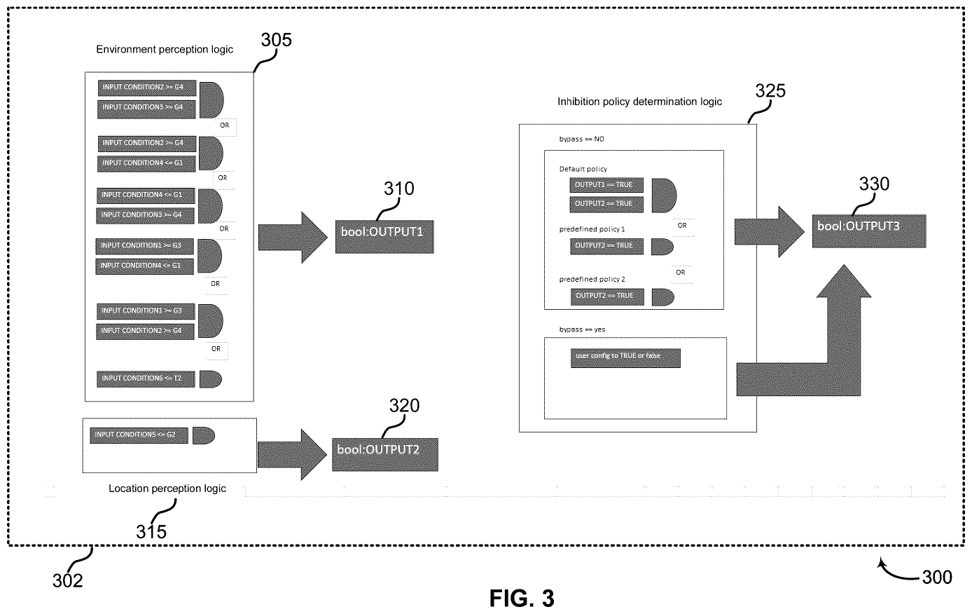

In some examples, the inhibition policy program 235 also processes manual user configurations through predefined rule sets, such as activating speed acceleration restrictions in all city areas and automatically deactivating them on highways, while maintaining safety-critical minimums. Details of the inhibition policy program 235's decision making process is further illustrated in FIG. 3.

FIG. 3 illustrates a flow diagram 300 of a decision-making method or process 302 according to some aspects. The flow diagram 300 shows the inhibition policy program 235 processes various input conditions to determine speed control actions.

The process 302 begins with collecting or otherwise obtaining information or conditions regarding the environment surrounding the vehicle 105. The conditions are shown in FIG. 3 as a set of conditions that are processed by logic components including an environment perception logic 305, a location perception logic 315, and an inhibition policy determination logic 325. In the example shown, the conditions processed by the environment perception logic 305 include multiple input conditions (INPUT CONDITION1 through INPUT CONDITION4 in FIG. 3) representing various environmental factors. These input conditions combine through logical operations to generate a boolean output (OUTPUT1) 310 indicating whether environmental conditions warrant speed acceleration restrictions. In the example shown, the location perception logic 315 uses a single condition (INPUT CONDITION5) to generate an output (OUTPUT2) 320 based on the vehicle's current location. The inhibition policy determination logic 325 then processes these outputs through different policy modes including a default policy, predefined policy 1, predefined policy 2, and a bypass mode that accepts user configurations. Inhibition policy determination logic 325 generates a final boolean output (OUTPUT3) 330 that determines whether to activate speed inhibition.

The following examples of area types show how the location perception logic 315 classifies and processes different area types through INPUT CONDITION5. Type 1 high caution areas include school zones, residential areas, and playgrounds where vulnerable road users are present. The location perception logic 315 classifies areas into two distinct types and processes them through INPUT CONDITION5. The two types may include high caution areas (Type 1) and open driving areas (Type 2). The high caution areas (Type 1) may include school zones, residential areas, and playgrounds where vulnerable road users are present. The open driving areas (Type 2) may include areas other than the high caution areas.

Based on these classifications, the location perception logic 315 generates OUTPUT2 320. For example, when the vehicle enters a Type 1 high caution area such as a school zone, the location perception sets OUTPUT2 to TRUE, signaling the need for speed acceleration restriction. Similarly, when transitioning from a Type 2 moderate caution area like a parking lot to a Type 4 open driving area such as a highway, OUTPUT2 changes to reflect the appropriate speed control requirements. In this example, the rain sensor level grades range from Grade 1 (no rain) indicating dry conditions with wipers off, to Grade 5 (torrential rain) indicating extreme precipitation requiring maximum wiper speed. For example, when INPUT CONDITION3 detects Grade 4 heavy rain with significantly reduced visibility, or Grade 5 torrential rain with severely impaired visibility, the environment perception sets OUTPUT1 310 to TRUE. In some examples, each rain sensor level grade is determined based on an amount of rain that falls over a period of time Rainfall intensity (RI) may be used to measure the amount of rain that falls over time. In these examples, the rain sensor level grade is determined based on the intensity of rain, which is measured in the height of the water layer that covers the ground over a period of time, such as over one hour. For example, there are four types of rain intensity classes including light rain (LR), where the intensity of rain is less than 0.5 mm h⁻¹, moderate rain (MR), wherein the intensity of rain is 2 mm h⁻¹ to 10 mm h⁻¹, heavy rain (HR), where the intensity of rain is 10 mm h⁻¹ to 50 mm h⁻¹, and violent rain (VR), where the intensity of train is greater than 50 mm h⁻¹.

The following examples of rain intensity grades show how the environment perception logic 305 processes rain conditions. The rain sensor level grades range from Grade 1 (no rain) indicating dry conditions with wipers off, to Grade 5 (torrential rain) indicating extreme precipitation requiring maximum wiper speed. The environment perception logic 305 combines these rain grades with other environmental conditions through logical OR operations. For instance, when INPUT CONDITION3 indicates Grade 4 heavy rain requiring high-speed wiper operation, or when INPUT CONDITION2 detects other severe weather conditions, the environment perception triggers OUTPUT1 310 to signal speed acceleration restriction requirements to the inhibition policy determination logic 325.

The following examples of visibility conditions show how the environment perception logic 305 processes visibility conditions through INPUT CONDITION4. The environment perception logic 305 processes visibility conditions through INPUT CONDITION4, analyzing visibility levels from Grade 1 (dark) to Grade 4 (glare). When INPUT CONDITION4 indicates Grade 1 low visibility conditions requiring full headlight activation, such as in tunnels or underground parking, or Grade 4 very bright conditions causing potential glare issues, the environment perception factors these conditions into OUTPUT 1 310. The environment perception combines visibility level grades with rain levels through its logical operations. For example, when INPUT CONDITION4 detects Grade 1 low visibility conditions AND INPUT CONDITION3 indicates Grade 4 heavy rain, the combination triggers OUTPUT1 310 to signal severely compromised visibility conditions. Similarly, when INPUT CONDITION4 detects Grade 4 very bright conditions causing glare, particularly in combination with wet road conditions and front visibility conditions, the environment perception logic 305 signals for speed acceleration restrictions.

The following examples of traffic grades show how traffic conditions affect speed control decisions, consider these examples of how the environment perception logic 305 analyzes real-time traffic through INPUT CONDITION1. The system processes traffic grades from Grade 1 (free flow) to Grade 4 (severe), with specific responses to conditions like Grade 3 heavy traffic. When INPUT CONDITION1 detects Grade 3 heavy traffic with stop-and-go conditions, or Grade 4 severe traffic with gridlock situations, the environment perception integrates these conditions into its OUTPUT1 310 calculation. The environment perception logic 305 evaluates traffic grades in conjunction with other environmental factors. For example, when INPUT CONDITION1 indicates Grade 3 heavy traffic AND INPUT CONDITION2 detects adverse weather conditions, the combination intensifies the need for speed acceleration restriction. The system processes traffic situations particularly carefully in complex scenarios such as when Grade 2 moderate traffic occurs in areas with mixed vehicle types like e-bikes, or when Grade 3 heavy traffic combines with Grade 4 low visibility conditions, the environment perception logic 305 adjusts OUTPUT1 310.

Accordingly, referring to FIG. 3, the environment perception logic 305 implements logical OR operations to combine multiple input conditions. When a condition exceeds its critical threshold, the environment perception sets OUTPUT1 310 to TRUE. For example, INPUT CONDITION2>=G4 OR INPUT CONDITION3>=G4 indicates either severe weather conditions or heavy rain triggers speed acceleration restriction. Similarly, Input Condition4<=G1 or Input Condition1>=G3 Shows That Either Very Low visibility conditions or heavy traffic situations warrant speed control.

It is possible for the vehicle control system 100 to determine or generate an environmental assessment using these logical combinations. For example, when the system detects INPUT CONDITION1 at Grade 3 (heavy traffic) combined through OR operation with INPUT CONDITION2 at Grade 4 (severe weather), the perception unit generates a TRUE output regardless of other visibility conditions. The environment perception logic 305 also processes scenarios where INPUT CONDITION4 (light sensor and camera sensor) indicates Grade 1 visibility condition, e.g., less than 20 meters, OR INPUT CONDITION3 (light sensor and camera sensor) shows Grade 4 visibility condition, e.g., more than 140 meters, outputting speed acceleration restrictions in response to compromised visibility situations.

The environment perception logic 305 processes weather service grades through INPUT CONDITION2, analyzing driving conditions from Grade 1 (clear) to Grade 5 (severe/dangerous). For example, when INPUT CONDITION2 detects Grade 4 poor conditions or Grade 5 dangerous conditions, this triggers the logical OR operation regardless of other environmental factors.

The inhibition policy determination logic 325 processes OUTPUT1 310 from environmental perception and OUTPUT2 320 from location perception to determine final speed control actions. In default policy mode, when both outputs indicate TRUE, the unit activates standard speed acceleration restrictions. The predefined policy modes implement specific restriction rules-for example, predefined policy 1 might combine Grade 3 traffic with Type 1 high caution areas to enforce stricter speed limits.

The bypass mode of the inhibition policy determination logic 325 processes user-configured settings while maintaining safety-critical minimums. For example, when bypass equals “NO”, the unit follows its default and predefined policies. When bypass equals “YES”, the unit accepts user configurations while still enforcing minimum safety thresholds based on environmental and location conditions. For example, the inhibition policy determination logic 325 generates OUTPUT3 330 based on the combined processing of all inputs and policies. For example, when operating in default policy mode with OUTPUT1 and OUTPUT2 both TRUE, OUTPUT3 330 triggers speed acceleration restriction. This final output determines whether to maintain current speed acceleration restrictions or allow normal vehicle operation based on the comprehensive analysis of all environmental, location, and policy conditions.

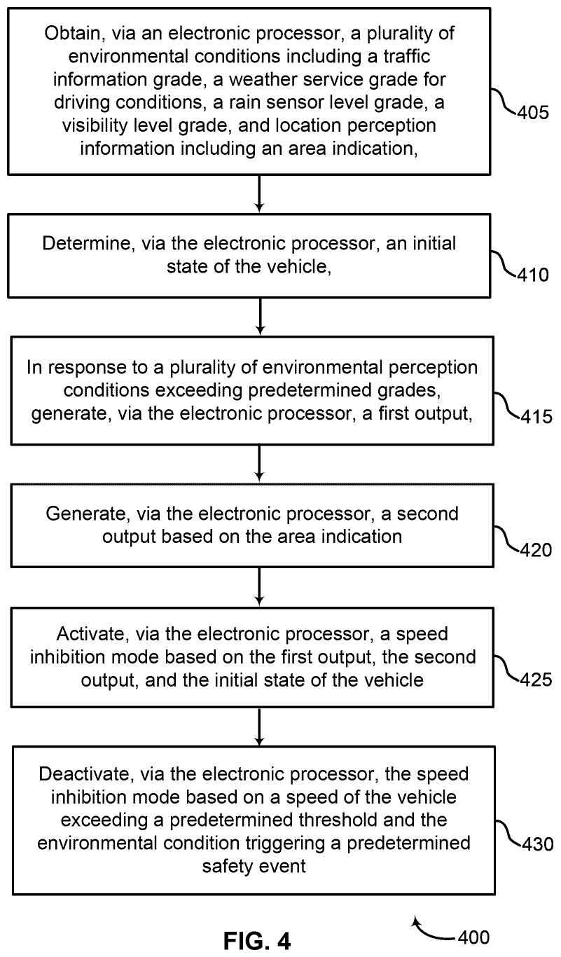

FIG. 4 illustrates a computer-implemented method 400 for controlling vehicle speed according to some examples. The computer-implemented method 400 is executed by the electronic processor 205 of the speed controller 110 in conjunction with other components of the vehicle control system 100.

At block 405, the electronic processor 205 obtains a plurality of environmental conditions. The plurality of environmental conditions includes a traffic information grade, a weather service grade for driving conditions, a rain sensor level grade, a visibility level grade, and location perception information including an area indication. The area indication may be determined based on a location type and a region type. In some examples, the electronic processor 205 obtains traffic information grades from the transceiver 130 from the vehicle environment service 150.

For visibility conditions, the rain sensor level “Grade 1” may indicate the rain condition “no rain,” and the rain sensor level “Grade 5” may indicate the visibility condition “heavy rain.” For visibility conditions, the visibility level “Grade 1” may indicate the visibility condition “less than 20 meters” and the visibility level “Grade 4” may indicate the visibility condition “more than 140 meters.” For location information, the electronic processor 205 receives GPS coordinates from the GNSS system 125 and determines area types ranging from “high-caution” to “open driving areas.”

At block 410, the electronic processor 205 determines an initial state of the vehicle. In some instances, the electronic processor 205 identifies the vehicle's current state as one of: a parking state when the vehicle transmission is in park, an ignition state when the vehicle is started but not in gear, or a driving state. The electronic processor 205 uses this state identification to set initial speed control parameters. For example, when the state transitions from parking to driving in a restricted area, the electronic processor 205 activates a set of speed inhibition parameters. In this example, when the state transitions from parking to driving in a restricted area, the electronic processor 205 sets maximum acceleration limits to 30% of normal capacity and restricts the top speed to 20 miles per hour. In some instances, the speed controller maintains the speed inhibition mode after vehicle ignition off and reactivate the speed inhibition mode upon next ignition on until the vehicle exits a restricted area.

At block 415, in response to a plurality of environmental perception conditions exceeding predetermined grades, the electronic processor 205 generates a first output. For example, when the weather service grade indicates hazardous conditions or the traffic information grade shows severe congestion, the electronic processor 205 generates the first output indicating a need for speed inhibition.

In some instances, the electronic processor 205 may generate boolean outputs based on the plurality of environmental conditions using logics as illustrated in FIG. 3. The electronic processor 205 compares each traffic information grade against a predetermined threshold to detect whether an environmental condition exceeds a predetermined threshold. For example, the predetermined threshold is 40 kilometers per hour. For example, the electronic processor 205 detects that a weather grade exceeds Grade 4 (hazardous) or a traffic grade exceeds Grade 3 (heavy). The electronic processor 205 then sets OUTPUT1 to TRUE, indicating speed control intervention is needed.

At block 420, the electronic processor 205 generates a second output based on the area indication. The area indication includes high caution areas and open driving areas. The electronic processor 205 sets the output to TRUE when the current location matches a high-caution or moderate-caution area type, indicating speed acceleration restriction is needed. The electronic processor 205 sets the output to FALSE for general driving areas and open driving areas where standard speed operation is permitted.

In some examples, the electronic processor 205 classifies location areas into different area indication categories based on risk levels from historical data. In some instances, the area indication is determined based on a location type and a region type. For high caution areas such as school zones and residential areas, the electronic processor 205 enforces a maximum speed of 15 miles per hour and limits acceleration to 20% of normal capacity. For open driving areas including highways and industrial zones, the electronic processor 205 enforces maximum permitted speeds and full acceleration capacity.

In some alternative examples, the electronic processor 205 predicts the area indication for a location area by predicting route options using a machine learning model trained on historical environmental data. The electronic processor 205 inputs current traffic grades, weather conditions, and location types into a logistic regression model. The model calculates probability scores for different route segments based on their historical risk levels. For example, when a route segment shows historical patterns of Grade 4 weather conditions during a time period, the electronic processor 205 assigns to the route segment a high risk score indicating a high caution area. Based on these scores, the electronic processor 205 may select routes that maintain risk scores below a predetermined threshold.

At block 425, the electronic processor 205 activates a speed inhibition mode based on the first output, the second output, and the initial state of the vehicle. The electronic processor 205 activates a speed inhibition mode when both first and second outputs are TRUE and the vehicle is in a driving state. The electronic processor 205 implements specific speed acceleration restrictions by sending control signals to vehicle drive and braking systems 115. When environmental conditions exceed Grade 3 (first output TRUE) and the location is classified as a high-caution area (second output TRUE), the electronic processor 205 limits vehicle speed to 15 miles per hour and acceleration to 20% capacity. When only one output is TRUE, the electronic processor 205 implements moderate restrictions of 20 miles per hour and 40% acceleration capacity.

In some instances, the electronic processor 205 stores the current restriction state in non-volatile memory before vehicle shutdown. When the vehicle ignition transitions from off to on, the electronic processor 205 reads this stored state from memory and verifies the vehicle's current location. When the vehicle remains in the same restricted area type, the electronic processor 205 reapplies the previously stored speed and acceleration restrictions. The electronic processor 205 maintains these restrictions until the vehicle's GPS coordinates indicate exit from the restricted area boundaries.

At block 430, The electronic processor 205 deactivates the speed inhibition mode based on a speed of the vehicle exceeding a predetermined threshold and the environmental condition triggering a predetermined safety event. For example, the electronic processor 205 deactivates the speed inhibition mode when two conditions are met. First, the vehicle speed exceeds 20 miles per hour, indicating stable vehicle operation. Second, at least one environmental condition improves to a predetermined safe level. These deactivation decisions may follow the logic flow illustrated in FIG. 3.

In some instances, the electronic processor 205 determines whether an environmental condition triggers a predetermined safety event. For weather conditions, a predetermined safety event occurs when weather service grades improve from Grade 4 (hazardous) to Grade 2 (fair). For traffic conditions, a predetermined safety event occurs when traffic information grades change from Grade 3 (heavy) to Grade 1 (free flow). For location conditions, a predetermined safety event occurs when vehicle GPS coordinates show transition from a restricted area to an open driving area. The electronic processor 205 deactivates speed acceleration restrictions when one or more of these predetermined safety events are triggered.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot register to push-to-talk communication networks, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . ,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A speed controller for a vehicle, the speed controller comprising:
a communication interface configured to receive location information; and
an electronic processor configured to:
obtain a plurality of environmental conditions including:
a traffic information grade,
a weather service grade for driving conditions,
a rain sensor level grade,
a visibility level grade, and
location perception information including an area indication,
determine an initial state of the vehicle,
in response to a plurality of environmental perception conditions exceeding predetermined grades, generate a first output,
generate a second output based on the area indication;
activate a speed inhibition mode based on the first output, the second output, and the initial state of the vehicle, and
deactivate the speed inhibition mode based on a speed of the vehicle exceeding a predetermined threshold and the environmental condition triggering a predetermined safety event.

2. The speed controller of claim 1, wherein the electronic processor is further configured to:
maintain the speed inhibition mode after vehicle ignition off; and
reactivate the speed inhibition mode upon next ignition on until the vehicle exits a restricted area.

3. The speed controller of claim 1, wherein determining the initial state of the vehicle comprises:
identifying a state of the vehicle as a parking state, an ignition state, or a driving state.

4. The speed controller of claim 1, wherein the area indication including a class of high caution areas following a high level of speed acceleration restrictions, and a class of open driving areas allowing maximum permitted speeds, wherein the area indication is determined based on a location type and a region type.

5. The speed controller of claim 1, wherein the electronic processor is further configured to:
predict a route option based on the plurality of environmental conditions using a machine learning model.

6. The speed controller of claim 1, wherein: the predetermined threshold is about 40 kilometers per hour; and the predetermined safety event includes at least one of: weather conditions being graded as clear or fair, traffic conditions being graded as free flow, or the location perception output indicating an open driving area.

7. The speed controller of claim 1, wherein the electronic processor is further configured to:
activate the speed inhibition mode based on user manual input.

8. A vehicle speed control system comprising:
a GNSS system configured to determine vehicle location;
a digital cockpit configured to display speed control information; and
a speed controller configured to:
obtain a plurality of environmental conditions including:
a traffic information grade,
a weather service grade for driving conditions,
a rain sensor level grade,
a visibility level grade, and
location perception information including an area indication,
determine an initial state of the vehicle,
in response to a plurality of environmental perception conditions exceeding predetermined grades, generate a first output,
generate a second output based on the area indication,
activate a speed inhibition mode based on the first output, the second output, and the initial state of the vehicle, and
deactivate the speed inhibition mode based on a speed of the vehicle exceeding a predetermined threshold and the environmental condition triggering a predetermined safety event.

9. The vehicle speed control system of claim 8, wherein the speed controller is further configured to:
maintain the speed inhibition mode after vehicle ignition off; and
reactivate the speed inhibition mode upon next ignition on until the vehicle exits a restricted area.

10. The vehicle speed control system of claim 8, wherein, to determine the initial state of the vehicle, the speed controller is further configured to:
identify a state of the vehicle as a parking state, an ignition state, or a driving state.

11. The vehicle speed control system of claim 8, wherein:
the area indication includes a class of high caution areas following a high level of speed acceleration restrictions, and a class of open driving areas allowing maximum permitted speeds, wherein the area indication is determined based on a location type and a region type.

12. The vehicle speed control system of claim 8, wherein the speed controller is further configured to: predict a route option based on the plurality of environmental conditions using a machine learning model.

13. The vehicle speed control system of claim 8, wherein the predetermined threshold is about 40 kilometers per hour; and the predetermined safety event includes at least one of:
weather conditions being graded as clear or fair, traffic conditions being graded as free flow, or the location perception output indicating an open driving area.

14. The vehicle speed control system of claim 8, wherein the speed controller is further configured to:
activate the speed inhibition mode based on user manual input.

15. A computer-implemented method for electric vehicle speed control, comprising:
obtaining, via an electronic processor, a plurality of environmental conditions including:
a traffic information grade,
a weather service grade for driving conditions,
a rain sensor level grade,
a visibility level grade, and
location perception information including an area indication,
determining, via the electronic processor, an initial state of the vehicle;
in response to a plurality of environmental perception conditions exceeding predetermined grades, generating, via the electronic processor, a first output,
generating, via the electronic processor, a second output based on the area indication;
activating, via the electronic processor, a speed inhibition mode based on the first output, the second output, and the initial state of the vehicle, and
deactivating, via the electronic processor, the speed inhibition mode based on a speed of the vehicle exceeding a predetermined threshold and the environmental condition triggering a predetermined safety event.

16. The computer-implemented method of claim 15, further comprising:
maintaining, via the electronic processor, the speed inhibition mode after vehicle ignition off; and
reactivating, via the electronic processor, the speed inhibition mode on upon next ignition until the vehicle exits a restricted area.

17. The computer-implemented method of claim 15, wherein determining the initial state of the vehicle comprises:
identifying, via the electronic processor, a state of the vehicle as a parking state, an ignition state, or a driving state.

18. The computer-implemented method of claim 15, wherein the area indication includes a class of high caution areas following a high level of speed acceleration restrictions, and a class of open driving areas allowing maximum permitted speeds.

19. The computer-implemented method of claim 15, further comprising:
predicting, via the electronic processor, a route option based on the plurality of environmental conditions using a machine learning model.

20. The computer-implemented method of claim 15, wherein the predetermined safety event includes at least one of weather conditions being graded as clear or fair, traffic conditions being graded as free flow, or the location perception output indicating an open driving area.
